(19) United States
(12) Patent Application Publication
(10) Pub. No.: US 2015/0113092 A1
(43) Pub. Date: Apr. 23, 2015

(54) METHOD AND APPARATUS FOR DISTRIBUTED ENTERPRISE DATA PATTERN RECOGNITION

(71) Applicant: FUTUREWEI TECHNOLOGIES, INC., Plano, TX (US)

(72) Inventors: Vineet CHADHA, San Jose, CA (US); Guangyu Shi, Cupertino, CA (US)

(73) Assignee: FUTUREWEI TECHNOLOGIES, INC., Plano, TX (US)

(21) Appl. No.: 14/061,620

(22) Filed: Oct. 23, 2013

(51) Int. Cl. G06F 3/06; G06F 15/173; G06F 9/455

(52) U.S. Cl. CPC G06F 3/067; G06F 9/45533; G06F 15/17331; G06F 3/0604; G06F 3/0658
USPC 709/214

(57) ABSTRACT

An apparatus for accessing data in an enterprise data storage system. The apparatus includes memory for storing data, a storage controller, a secure hypervisor, and an interface. The storage controller is coupled to the memory and is configured for managing data stored in the memory. The controller is also configured to receive a command from a client device to access specified data in the memory. The secure virtualized hypervisor within the memory is configured for deploying an operating system of the storage controller for purposes of secure operation by the storage controller. The interface is configured for communicating with the storage controller and initiates the storage controller to perform the command on the specified data that is fetched into the secure virtualized hypervisor, wherein results of the command is transmitted over a network to the client device.

### BACKGROUND

Enterprise data storage devices are used to provide high end storage services to the end user. These services include data access, storage, queries etc. Typically, enterprise data storage is connected to commodity desktop system or network of desktop systems to provide data services to the network. To access data in such scenario, protocol goes through network, firewalls and other software layer. The overhead could be significant if it involves moving large or significant amount of data.

Currently, enterprise data in distributed systems is accessed through an established session and set of operation commands between the network of desktop systems and the enterprise data storage devices. While the data is fetched based on the offset and size, semantics of search operations are applied in a corresponding desktop node. That is, the data is fetched from the enterprise data storage devices and delivered over the network back to the corresponding and requesting desktop system.

Additionally, a scan or search operation on large amounts of data requires multiple preliminary operations before performing the scan or search. This is because the data is fetched from the enterprise data system and delivered to the requesting desktop. For instance, preliminary operations include open and recall operations. As a drawback, the greater the size of data being fetched requires increased time to perform operations on the data also increases.

It is desirable to decrease the access and execution time when performing operations on data stored on one or more enterprise data storage devices.

### SUMMARY

An apparatus for accessing data in an enterprise data storage system, wherein the apparatus includes memory for storing data, a storage controller, a secure hypervisor, and an interface. The storage controller is coupled to the memory and is configured for managing data stored in the memory. The controller is also configured to receive a command from a client device to access specified data in the memory. The secure virtualized hypervisor (e.g., container, sandbox, etc.) within the memory is configured for deploying an operating system of the storage controller for purposes of secure operation by the storage controller. The interface is configured for communicating with the storage controller and initiates the storage controller to perform the command on the specified data that is fetched into the secure virtualized hypervisor, wherein results of the command is transmitted over a network to the client device.

In other embodiments, an apparatus for accessing data is disclosed. The apparatus includes a network attached storage (NAS) storage controller for accessing data in a NAS data store. The apparatus also includes a secure virtualized hypervisor (e.g., container, sandbox, etc.) for deploying an operating system of a network attached storage (NAS) storage controller. The hypervisor is configured to provide secure operation by the NAS storage controller, wherein said NAS storage controller is configured for receiving a command and associated command parameters that are migrated from an application executed by a client device to the NAS storage controller for purposes of accessing specified data stored in the NAS data store. In particular, the specified data is fetched into the secure virtualized hypervisor and the command is executed by the NAS storage controller on the specified data within the secure virtualized hypervisor.

In one embodiment, a computer system comprises a processor coupled to memory having stored therein instructions that, if executed by the computer system, cause the computer to execute a method for accessing data. The method includes receiving at a storage controller a command and associated command parameters from a client device to access specified data stored in a data store. The storage controller manages access to the data store, wherein the storage controller and the data store comprise an enterprise data system. The method also includes deploying an operating system of the storage controller within a secure virtualized hypervisor (e.g., container, sandbox, etc.) within the enterprise data system for purposes of secure operation by the storage controller. The method also includes fetching the specified data from the data store as directed by the storage controller when executing the command. The method also includes performing the command on the data stored n the hypervisor as directed by the storage controller.

In some embodiments, an apparatus includes a tangible, non-transitory computer-readable storage medium having stored thereon, computer-executable instructions that, when executed causes the computer system to perform a method for accessing data. The method includes receiving at a storage controller a command and associated command parameters from a client device to access specified data stored in a data store. The storage controller manages access to the data store, wherein the storage controller and the data store comprise an enterprise data system. The method also includes deploying an operating system of the storage controller within a secure virtualized hypervisor (e.g., container, sandbox, etc.) within the enterprise data system for purposes of secure operation by the storage controller. The method also includes fetching the specified data from the data store as directed by the storage controller when executing the command. The method also includes performing the command on the data stored n the hypervisor as directed by the storage controller.

These and other objects and advantages of the various embodiments of the present disclosure will be recognized by those of ordinary skill in the art after reading the following detailed description of the embodiments that are illustrated in the various drawing figures.

### BRIEF DESCRIPTION

The accompanying drawings, which are incorporated in and form a part of this specification and in which like numerals depict like elements, illustrate embodiments of the present disclosure and, together with the description, serve to explain the principles of the disclosure.

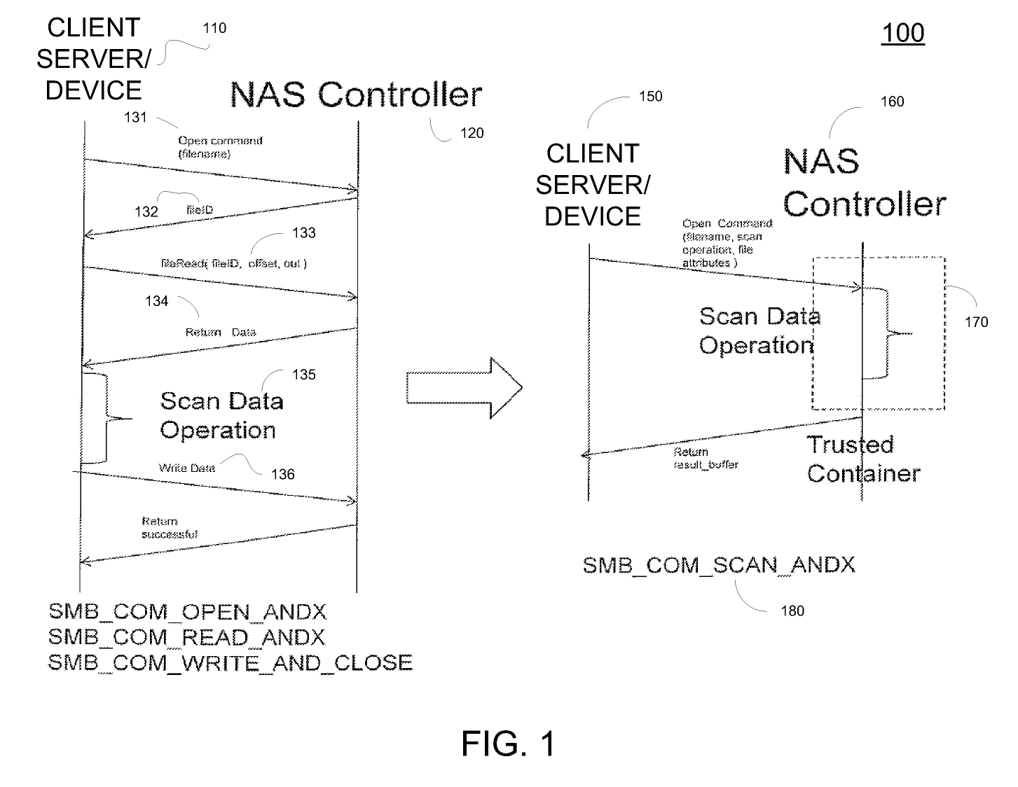

FIG. 1 is an data flow diagram illustrating the process for accessing data by offloading intensive scan or search input/output (I/O) operations to a back end storage controller for execution, in accordance with one embodiment of the present disclosure.

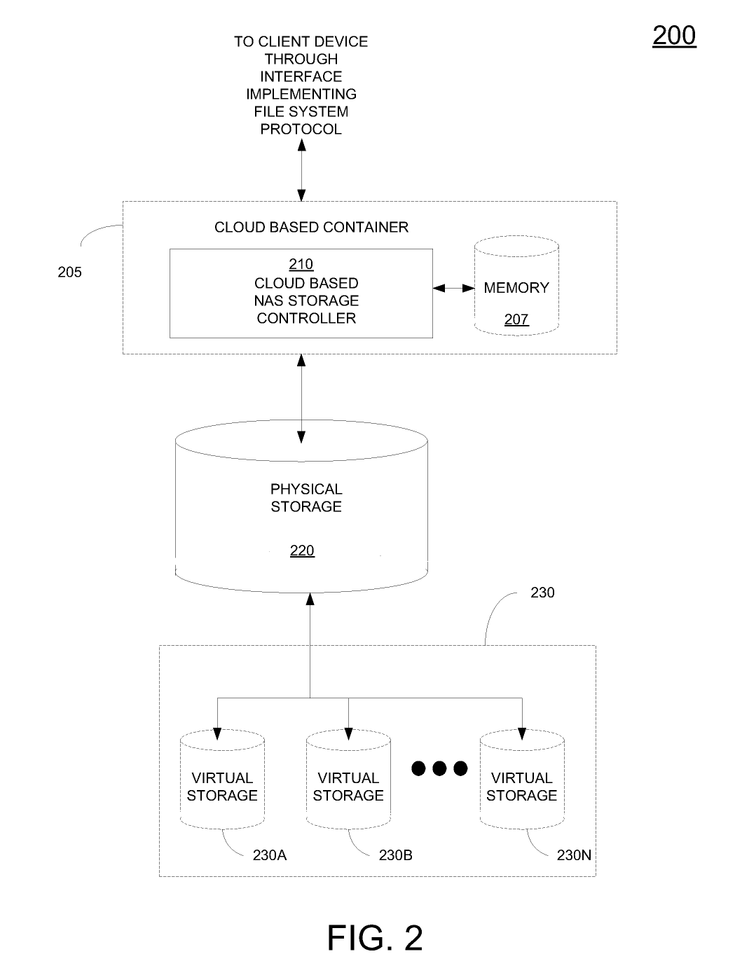

FIG. 2 is a block diagram of a back end storage controller apparatus configured for accessing data from an enterprise data storage system by performing offloaded intensive scan and/or search I/O operations at the storage controller, in accordance with one embodiment of the present disclosure.

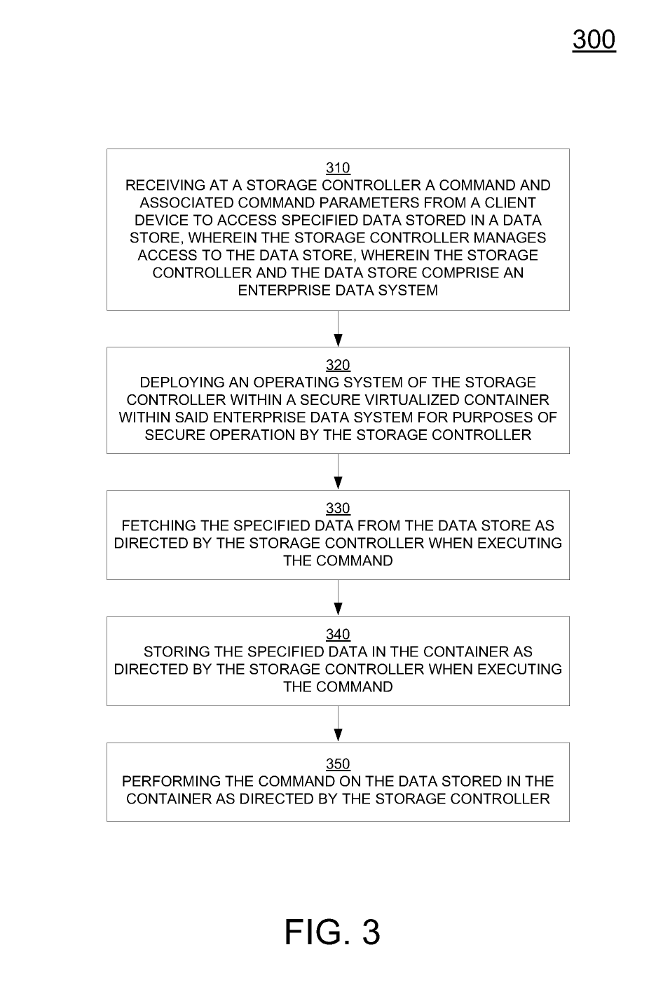

FIG. 3 is a flow diagram illustrating a method of accessing data by offloading intensive scan or search input/output (I/O) operations to a back end storage controller for execution, in accordance with one embodiment of the present disclosure.

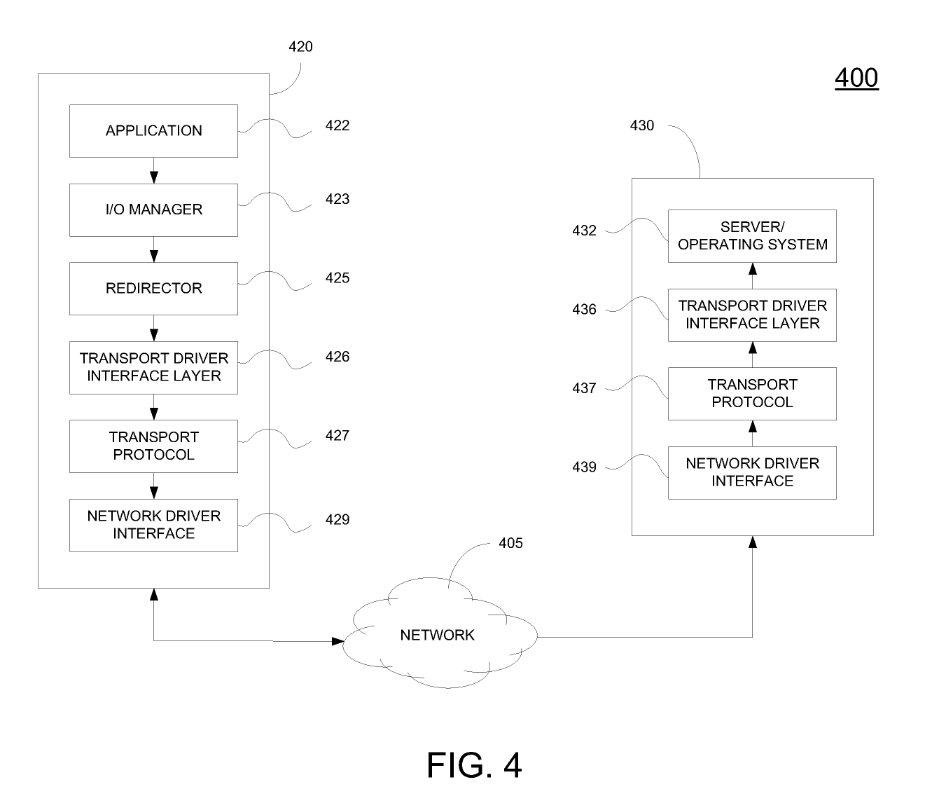

FIG. 4 is an illustration of a distributed architecture of a common internet file system (CIFS) used for communicating requests to access data to and from an enterprise data storage system, wherein the CIPS protocol is expanded to include semantics based search or file pattern recognition operations to be performed at a backend server and/or storage controller for accessing data in an enterprise data storage system, in accordance with one embodiment of the present disclosure.

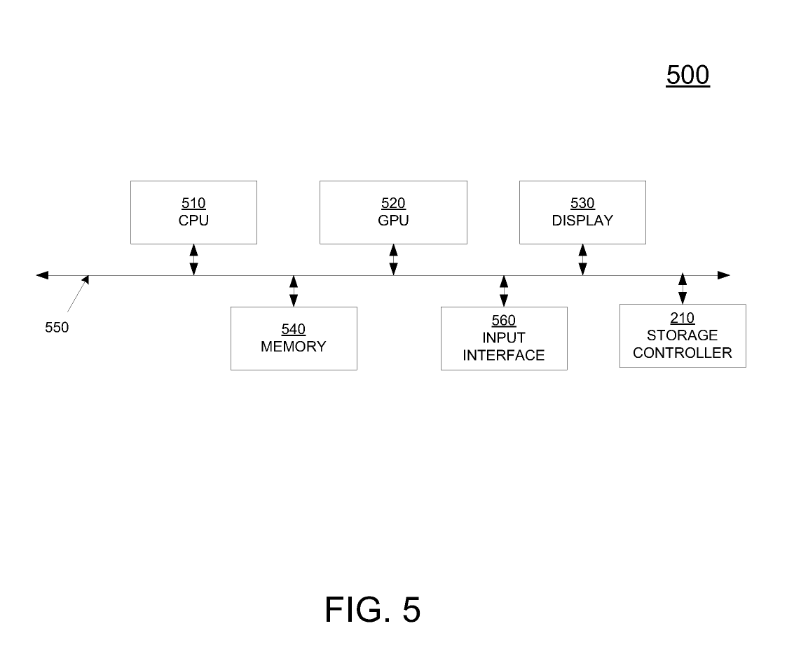

FIG. 5 depicts a block diagram of an exemplary computer system suitable for implementing the present methods in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Accordingly, embodiments of the present disclosure provide for accessing data from enterprise data storage systems to perform scan and/or search operations at a back end storage controller. Other embodiments provide the above accomplishment and further provide for performing scan and/or search operations at a back end storage controller without going through a network, firewall, and other software layers. Still other embodiments provide the above accomplishments and further provide for accessing data from enterprise data storage systems and performing operations on that data without transferring targeted data back to a requesting server. Still other embodiments provide the above accomplishments and further provide that no significant changes in present I/O scheduling mechanism are needed except that I/O operations with multi-component search semantics will improve the application performance, and thus make scarce resources available for more multiplexing applications. Still other embodiments provide the above accomplishments and further provide for cloud-based virtualization of resources at a back-end NAS gateway device (e.g., specialized containers or sandboxes), such that the virtual resources are scalable and each use less processing power and require less memory space, thereby providing more resources for I/O operations.

Embodiments of the present disclosure provide for methods and systems to securely offload search and pattern recognition application operations to a back end storage controller when accessing data of an enterprise data storage system. In particular, embodiments of the present disclosure provide for embedding search or pattern recognition operations into de facto enterprise file sharing protocol, such as a server message block (SMB) or common internet file system (CIFS) protocols; moving embedded search and/or scan operation nearer to the data and tapping resources available at the NAS storage controller; and using secure environments such as a virtual container to allow the search and/or scan operations to execute securely in the back end storage controller (e.g., NAS device).

FIG. 1 is an data flow diagram illustrating the process for accessing data by offloading intensive scan or search input/output (I/O) operations to a back end storage gateway device (e.g., storage controller) for execution, in accordance with one embodiment of the present disclosure. In particular, FIG. 1 illustrates the use of the CIFS protocol to read data from NAS storage device.

As shown, the typical method for accessing data from an enterprise storage system involves a client server 110 and a NAS gateway device or storage controller 120, wherein the storage controller 120 is used as an interface to manage and access data within a data store, such as, network attached storage. In the traditional method, enterprise data located in distributed enterprise data storage systems is accessed through an established session and set of operation commands. These operations may be communicated through an established file system protocol (e.g., CIFS, SMB, etc.). The intensive scan and/or search I/O operations are performed at the client server node 110, requiring that data be fetched and delivered to the client server node 110.

Currently, multiple CIFS commands are used to open the file, read the data blocks file, and operate on the data on the client server 110. For instance, a typical message exchange for accessing data in the enterprise data store includes an open command 131 (e.g., SMB_COM_OPEN_ANDX) delivered from the client server to the NAS device 120. A fileID (e.g., identifier) 132 is returned to the client device 110. The client device 110 then sends a read command 133 to read the data blocks file (e.g., SMB_COM_READ_ANDX), that includes additional information, including for example, a fileID and offset. The storage controller 120 accesses the data from the data store and returns the data at 134.

After the data is fetched and delivered to the client device 110, the requested I/O operations (e.g., scan and/or search) 135 are performed at the client device 110. A result of the operation is realized. Based on the results, a write operation 135 is delivered back to the NAS device 120 and performed on the data located at the back end data store (not shown) that is controlled by the NAS device 120. A return message 137 is delivered back to the client device 110, indicating a successful return when conditions are satisfied (e.g., SMB_COM_WRITE_AND_CLOSE).

Embodiments of the present disclosure provide for securely offloading search and/or scan (e.g., pattern recognition) operations as requested by an application on a client device to a back end storage controller (e.g., NAS device) for performing data intensive application operations in an enterprise data storage system. The offloading of operations is based on the assumption that data is large and the communication sequence to fetch the data would be significant to cause a bottleneck in application performance.

As shown in FIG. 1, embodiments of the present invention provide for the offloading of intensive I/O operations initiated at a client device 150 to a back end NAS gateway device 160 (e.g., NAS storage controller). For instance, a multi-component scan and/or search operation (e.g., “open” command) is delivered from the client device 150 to the NAS device 160. In particular, search and pattern recognition operations are embedded into eh file system protocol used for accessing the memory associated with the back end NAS gateway device 160. The file sharing protocol is extended to include the command that includes at least one of the search and pattern recognition operations, wherein the command includes at least one of the following: an open command, a read command, a search command, a scan command, and a write command.

That is, semantics aware applications as installed at the client server 150 are configured to migrate complex multi-component operations to a back-end NAS gateway device 160. As an example, the multi-component “scan” operation 180 (SMB_COM_SCAN_ANDX) includes an “open” command, a “filename”, a “scan” operation, file attributes, etc. the multi-component operations is embedded into the existing file system protocol (e.g., CIFS, SMB, etc.). As a result, the scan and/or search operation is offloaded to the NAS device 160, and executed by the NAS gateway device 160.

For example, the NAS gateway device 160 may represent any commercial NAS gateway device that provides different configuration of system resources. Typically, system resources in the NAS gateway devices varies widely from the high end to low end devices. For example, a high end NAS gateway device is configured with 64-bit 6-core, Intel Xeon 2.93 GHz 192 GB, a low end NAS gateway device is configured with single core ARM 9 (370 MHz), 256 MB. Embodiments of the present invention provide for gateway devices 160 that are configured to access data by offloading intensive scan or search input/output (I/O) operations to a back end storage gateway device (e.g., storage controller) for execution, in accordance with one embodiment of the present disclosure.

As shown in FIG. 1, the scan and/or search operation offloaded to the NAS device 160 is executed within a secure environment 170. In one embodiment, the secure environment 170 is implemented within a cloud based hypervisor that is configured to support the operating system of a virtualized NAS device 160 (e.g., storage controller), such as, performing I/O operations. For instance, in one embodiment the secure environment 170 comprises a container, and in another embodiment, the secure environment 170 comprises a sandbox. For purposes of the present disclosure, a sandbox is intended as a construct defining a security mechanism for secure operation of applications, or separation of running applications. The sandbox typically includes a tightly controlled set of virtual resources (cloud based or local) for the execution of applications. Access to the resources within the sandbox is tightly managed. The sandbox environment is implemented within a light-weight mechanism to provide high scalability for large scale server I/O requests. As an example, custom sandboxes or library based sandboxes are used to improve cloud application performance, and are highly scalable because of their low hypervisor footprint in memory.

FIG. 2 is a block diagram of a storage controller apparatus 210 configured for accessing data from the enterprise data storage system 200 by performing offloaded intensive scan and/or search I/O operations at the storage controller 210, in accordance with one embodiment of the present disclosure. The operations performed by the storage controller apparatus 210 is implementable within the NAS device 160 of FIG. 1, in one embodiment.

As shown, the enterprise data storage system 200 includes a memory for storing data. For instance, the memory includes physical storage 220 that is configured for storing data. The enterprise data storage system 200 is configured for large, scale high technology environments, and is highly scalable, has better fault tolerance, and high reliability. As such, the physical storage 220 is configured as one or more virtual storage devices 230A-N within a virtual memory 230 that is configured to map virtual memory addresses to physical memory addresses across one or more physical storage devices. Virtual storage devices 230A-N generally represent any type or form of storage device or medium capable of storing data and/or other computer-readable instructions. Storage devices 230A-N may represent network-attached storage (NAS) devices, and are coupled to a NAS storage controller 210.

The storage controller 210 is coupled to the memory, and is configured for managing data stored in the memory (e.g., virtual storage devices 230A-N) using any suitable file system protocol. Further, the NAS storage controller 210 is coupled to a remote client device (not shown) through a communication network. In particular, the storage controller 210 is configurable for receiving a command from the client device to access specified data stored in said memory. The command is initiated from an application running on the client device. For example, the command may include one or more data intensive search and/or scan I/O operations.

In one embodiment, communication is enabled between the client device, NAS storage controller 210, and the virtual storage devices 230A-N using an interface, wherein the interface is configured for allowing applications to access and make requests for files and services provided by the enterprise data system 200. That is, the interface provides for communication between the client device and the storage controller 210 such that the interface initiates the storage controller 210 to perform requested commands on specified data. For instance, the interface includes various communication interfaces and/or protocols, such as Network File System (NFS), Server Message Block (SMB), or Common Internet File System (CIFS). In one embodiment, the communication interface is implemented through a web browser or through other client software.

In one embodiment, the storage controller (e.g., NAS storage controller) 210 is implemented within a cloud based secure environment 205. In one implementation, the cloud based secure environment comprises a container, such as, a secure virtualized container that is configured for deploying an operating system of the storage controller for purposes of secure operation by the storage controller. In another implementation, the cloud based secure environment comprises a sandbox, as previously described. In other implementations, the secure environment 205 is virtualized using the memory resources from physical storage 220.

More specifically, the specified data is fetched from virtual memory 230A-N in the enterprise data storage system 200 and stored into memory 207 in the secure virtualized container 205. The requested operations are executed by the NAS storage controller 210 within the cloud based secure virtualized container 205, and results of the execution of the command is transmitted over a communication network back to the client device.

FIG. 3 is a flow diagram illustrating a method of accessing data by offloading intensive scan or search input/output (I/O) operations to a back end storage controller for execution, in accordance with one embodiment of the present disclosure. In one embodiment, flow diagram 200 illustrates a computer implemented method of accessing data by offloading intensive scan or search input/output (I/O) operations to a back end storage controller for execution, in accordance with one embodiment of the present disclosure. In another embodiment, flow diagram 200 is implemented within a computer system including a processor and memory coupled to the processor and having stored therein instructions that, if executed by the computer system causes the system to execute a method for accessing data by offloading intensive scan or search input/output (I/O) operations to a back end storage controller for execution. In still another embodiment, instructions for performing the method are stored on a non-transitory computer-readable storage medium having computer-executable instructions for causing a computer system to perform a method for accessing data by offloading intensive scan or search input/output (I/O) operations to a back end storage controller for execution as outlined by flow diagram 300. The operations of flow diagram 300 are implemented within the system 510 of FIG. 5 and/or storage controller 210 of FIG. 2, in some embodiments of the present disclosure.

FIG. 3 discloses a methodology to offload I/O intensive scan or search operation using embedded conventional enterprise file system protocols such as CIFS and its variations. As will be further described, implementation of migrating or offloading I/O operations to a back end storage controller for execution includes a modified application programming interface or communication interface (API) used for requesting access to data on remote servers or enterprise data systems, embedded operations with search operation semantics, and execution of operations within a secure virtualized environment (e.g., specialized sandbox mechanism based on native client, such as, a Google native client).

At 310, the method includes receiving at a storage controller a command and associated command parameters from a client device to access specified data stored in a data store, wherein the storage controller and the data store comprise an enterprise data system. More particularly, the storage controller manages access to the data store. The command includes at least one of a search and pattern recognition (e.g., scan, which as an example is used to scan for viruses or conditions).

At 320, the method includes deploying an operating system of the storage controller within a secure virtualized environment or hypervisor (e.g., container, sandbox, etc.) for purposes of secure operation by the storage controller. In one embodiment, the secure virtualized hypervisor is implemented within a cloud based infrastructure that is separate from the data store of the enterprise data storage system. In another embodiment, the secure virtualized hypervisor is implemented within the data store of the enterprise data storage system.

More particularly, at 330, the method includes fetching the specified data from the data store as directed by said storage controller when executing the command. At 340, the method includes storing the specified data in memory associated with the hypervisor as directed by the storage controller when executing the command. As such, instead of transporting the specified data back to the requesting client device, embodiments of the present invention transport the specified data back to the internal storage controller, and without going through an external communication network, or firewall separating an external network from the enterprise data storage system.

At 350, the method includes performing the command on the specified data that is stored in the memory associated with the hypervisor as directed by the storage controller when executing the command. As such, the execution of the requested operations is performed securely in the storage controller located within the hypervisor. Furthermore, a result of the performing the command is generated. This result is then delivered to the client device from the storage controller.

In one implementation, the hypervisor is configured by leveraging a light weight virtualization mechanism based on library OS to execute a search and/or scan operation securely inside the NAS storage controller. For instance, a native client technology enables execution of natively compiled code into a web browser for implementing the storage controller within a hypervisor environment. One goal of the native client is to provide a secure virtualized environment (e.g., through a sandbox) for execution of natively compiled user code in the browser application.

A sandbox is implemented using two different approaches according to embodiments of the present invention. The first approach is based on filtering or grouping the processes for the access restrictions. The second approach is based on enforcing different abstractions (as in case of para virtualized virtual machines). The second approach is often also classified as library based operating system, such that the library based operating system is configured to provide a secure environment for application execution. These approaches allow for seamless execution of cloud workloads securely in the backend computing resources.

An example approach of a library based operating system is zeroVM, which is based on a Google native client sandbox technique. In this implementation, operating system (O/S) abstraction is very limited so as to expose very small surface of attack. The ZeroVM consists of Google Native client, Zero Message queue for messaging and Message pack. The native client is designed to run foreign application (e.g. graphics, audio) using a browser.

For communication, the library based operating system (e.g., ZeroVM) has multiple channels (e.g. random read and sequential write). Two kinds of applications can be plugged-in within the ZeroVM virtual machine implementation: static and dynamic. Since the native client supports a small set of applications, the library based operating system as implemented by ZeroVM supports limited applications that can be dynamically linked. The search and/or scan operations are plugged inside the virtual machine so as to run them securely in the NAS storage controller.

In one embodiment, only small subsets of programs can be dynamically linked with ZeroVM. The main idea behind the library based system (also known as ekokernels) is to give application access to some specified aspect (albeit small) of an operating system. The use of exokernels reduces the abstraction typically offered by monolithic operating systems. O/S functionality is exported to user level and possibly an application is linked dynamically with specialized O/S runtime and specialized device driver to remove the overhead incurred in traditional operating systems, in one embodiment.

Communication between the client device, storage controller as implemented within a secure virtualized hypervisor, and the data store of the enterprise data storage system is implemented through an interface, such as, a file system protocol. In one embodiment, the search and pattern recognition operations are embedded into the enterprise file sharing protocol used for accessing the enterprise data system. This is accomplished by extending the file sharing protocol to include the command, wherein the command includes multiple components including at least one of an open command, a read command, a search command, a scan command, and a write command. In one implementation, the interface is the CIFS protocol, which is further described below for purposes of illustration only. That is, the discussion of the CIFS protocol is representative of file system protocols in general, such as, SMB, etc.

CIFS is a distributed file system protocol used to access the user data from a backend server device. For example, CIFS is a de facto way of sharing files in an enterprise data storage system with other remote servers. CIFS architecture consists of multiple software layers that is used to fetch the shared file data over a communication network on computers. CIFS (and its variants) is a command based protocol.

When establishing a CIFS communication session, a session ID is established between client device and a back end server (e.g., storage controller) through a series of message exchanges. This step includes the user authentication and security check for the permission to access the files. Further, a command is delivered from the client device to the storage controller over the established communication session or channel to operate on the data residing on the data store of the enterprise data storage system. For example, CIFS is a state full protocol where client information is kept for open file or files which are being currently operated on. Typical use cases of CIFS include network file sharing, printing services etc.

FIG. 4 is an illustration of a distributed architecture 400 of a common internet file system (CIFS) used for communicating requests to access data to and from an enterprise data storage system, wherein the CIPS protocol is expanded to include semantics based search or file pattern recognition operations to be performed at a backend server and/or storage controller for accessing data in an enterprise data storage system, in accordance with one embodiment of the present disclosure.

As shown, a request from an application 422 executing on a client device 420 is directed through the I/O manager 423 layer, and the redirector layer 425 to the underlying transport interface layer (TDI) 426. CIFS support multiple protocols to transfer the data to/from the client device 420 (e.g. NetBIOS, NERBT). A typical system call from the application 422 is converted into a command to operate on the data (stored remotely at the enterprise data storage system) based on well defined file system interface (e.g., the enterprise file sharing protocol) at layer 427. The network driver interface connects to the network 405 to deliver the command to the back end storage controller device 430. The storage controller 430 is similarly configured with a network driver interface 439 configured to connect to the network 405, a transport protocol layer 437, and a transport driver interface layer 436. In this manner, a search and/or scan operation migrated to the storage controller 430 is executed within the operating system 432 or server application layer 432.

As an illustration of the operation of CIFS in a typical CIFS based distributed file system protocol, consider an example of read protocol, first described in FIG. 1. First, a file is opened through an open command, with the following example operation: “SMB_COM_OPEN_ANDX”. Typically, parameters include user identification number, session ID, client process ID, and buffer to store the file name. Then, the storage controller server will return the file ID for a successful open command request. To read the file, the client sends a command with encoded information on offset and count (in addition to other relevant information), with the following example operation: “SMB_COM_READ_ANDX”.

On the other hand, embodiments of the present disclosure extends the list of CIFS command to include semantics based search or file pattern recognition at the backend server for enterprise application. This extension is also applicable to other domain of applications using CIFS. An example use case could be user's activity data (in terabytes) shared through CIFS for an application to operate on. Through CIFS, file data is fetched into the storage controller address space and then the necessary operation is conducted on the top of it by the storage controller. Reading data and operating a search operation is a very frequent operation with emerging workloads such as big data analytics.

In one embodiment, a new extension is established to the application API to facilitate meta or multi-component operations such as read-plus-scan operations, so as to tap the resources on the backend server (e.g., storage controller). This involves migrating a key application operation to the backend server (e.g., storage controller). As such, security is critical concern.

In one embodiment, a light weight virtualization mechanism based on a library operating system is implemented for executing the requested operation securely. The library operating system (e.g., operating system of the storage controller) is implemented through a virtualization, which takes a very small footprint of memory in terms of execution environment.

In another embodiment, a proposed command for scanning or searching file is described below. As shown, the command includes multiple components wrapped into a single “scan command.” Typical syntax consists of protocol level details used for exchanging data and attributes at a back end NAS device. Semantics is applied on top of the syntax. In embodiments of the present invention, syntax and semantics are combined, wherein the semantics is embedded into the CIFS command operation for search and/or scan file objects.

Command: SMB_COM_SCAN_ANDX
TID: Set to the server-returned TID from the tree connects response
PID: Set to process ID of client process.
UID: Set to the server-returned UID from the session setup response
MID: Any unique number.
WordCount: 10

The command includes parameter words, wherein the FID is stated so the server knows which opened file is referred to by the client device. File scan operation and condition is also specified and embedded. Further, the bytecount is set to 0. Also, the buffer is filled up with the executed operation.

To execute the search and/or scan operation on large scale files (e.g. multiple gigabytes), the NAS device operating system is deployed or configured with highly scalable virtual machines (e.g. ZeroVM, microXen), in one embodiment. As a result, search and/or scan operations that are executed within the NAS device can be applied with a template manifest so as to execute the search operation in a constrained and secured environment. For example, the manifest to configure the virtual machine or sandbox, or container environment can be configured dynamically based on file attributes, operation and system resources. As a result, extended CIFS commands provide for remote search and/or scan operations as executed on a remote storage controller device as implemented within a highly scalable secure virtualized environment (e.g., container, sandbox, etc.).

Typically, various abstraction layers are added on the top of storage appliance so as to provide customized services for the client device request (e.g., Linux LUN or volume used to provide the abstraction of capacity). In embodiments, multiple categories for the templates can be added to be applied to the search operation, such as capacity, throughput, and virtualization.

FIG. 5 is a block diagram of an example of a computing system 500 capable of implementing embodiments of the present disclosure. Computing system 500 broadly represents any single or multi-processor computing device or system capable of executing computer-readable instructions. Examples of computing system 500 include, without limitation, workstations, laptops, client-side terminals, servers, distributed computing systems, handheld devices, or any other computing system or device. In its most basic configuration, computing system 500 may include at least one processor 510 and a system memory 540.

Both the central processing unit (CPU) 510 and the graphics processing unit (GPU) 520 are coupled to memory 540. System memory 540 generally represents any type or form of volatile or non-volatile storage device or medium capable of storing data and/or other computer-readable instructions. Examples of system memory 540 include, without limitation, RAM, ROM, flash memory, or any other suitable memory device. In the example of FIG. 5, memory 540 is a shared memory, whereby the memory stores instructions and data for both the CPU 510 and the GPU 520. Alternatively, there may be separate memories dedicated to the CPU 510 and the GPU 520, respectively. The memory can include a frame buffer for storing pixel data drives a display screen 530.

The system 500 includes a user interface 560 that, in one implementation, includes an on-screen cursor control device. The user interface may include a keyboard, a mouse, and/or a touch screen device (a touchpad).

CPU 510 and/or GPU 520 generally represent any type or form of processing unit capable of processing data or interpreting and executing instructions. In certain embodiments, processors 510 and/or 520 may receive instructions from a software application or hardware module. These instructions may cause processors 510 and/or 520 to perform the functions of one or more of the example embodiments described and/or illustrated herein. For example, processors 510 and/or 520 may perform and/or be a means for performing, either alone or in combination with other elements, one or more of the monitoring, determining, gating, and detecting, or the like described herein. Processors 510 and/or 520 may also perform and/or be a means for performing any other steps, methods, or processes described and/or illustrated herein.

Further, system 500 includes a storage controller 210 that is configured for operation within an enterprise data system that securely offloads search and pattern recognition application operations to the back end storage controller 210 when accessing data of an enterprise data storage system, in accordance with one embodiment of the present disclosure.

In some embodiments, the computer-readable medium containing a computer program may be loaded into computing system 500. All or a portion of the computer program stored on the computer-readable medium may then be stored in system memory 540 and/or various portions of storage devices. When executed by processors 510 and/or 520, a computer program loaded into computing system 500 may cause processor 510 and/or 520 to perform and/or be a means for performing the functions of the example embodiments described and/or illustrated herein. Additionally or alternatively, the example embodiments described and/or illustrated herein may be implemented in firmware and/or hardware.

Embodiments of the present disclosure may be implemented by using hardware only or by using software and a necessary universal hardware platform. Based on such understandings, the technical solution of the present disclosure may be embodied in the form of a software product. The software product includes a number of instructions that enable a computer device (personal computer, server, or network device) to execute the method provided in the embodiments of the present disclosure.

Embodiments described herein may be discussed in the general context of computer-executable instructions residing on some form of computer-readable storage medium, such as program modules, executed by one or more computers or other devices. By way of example, and not limitation, the software product may be stored in a nonvolatile or non-transitory computer-readable storage media that may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), USB flash disk, digital versatile disks (DVDs) or other optical storage, magnetic cassettes, magnetic tape, removable hard disk, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

Thus, according to embodiments of the present disclosure, systems and methods are described for securely offloading search and pattern recognition application operations to a back end storage controller when accessing data of an enterprise data storage system.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present invention and its advantages have been described in detail, it should be understood that various changes substitutions, and alterations can be made herein without departing from the spirit and scope of the invention as defined by the appended claims. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

1. An apparatus, comprising:
memory for storing data;
a storage controller coupled to said memory configured for managing data stored in said memory, wherein said storage controller is configurable for receiving a command from a client device to access specified data stored in said memory;
a secure virtualized hypervisor within said memory for deploying an operating system of said storage controller for purposes of secure operation by said storage controller;
an interface configured for communicating with said storage controller such that said interface initiates said storage controller to perform said command on said specified data that is fetched into said secure virtualized hypervisor, wherein results of said command is transmitted over a network to said client device.

2. The apparatus of claim 1, wherein said storage controller and said memory comprise an enterprise data system, wherein said enterprise data system comprises a network attached storage (NAS) including said memory, and said storage controller comprises a NAS controller.

3. The apparatus of claim 1, further comprising:
search and pattern recognition operations embedded into said interface, wherein said interface comprises an enterprise file sharing protocol used for accessing data in said memory, and wherein said enterprise file sharing protocol is extended to include said command comprising at least one of said search and pattern recognition operations.

4. The apparatus of claim 3, wherein said command comprises multiple components including at least one of an open command, a read command, a search command, a scan command, and a write command.

5. The apparatus of claim 1, further comprising a communication session established between said client device and said storage controller.

6. The apparatus of claim 1, wherein said interface comprises at least one of a common internet file system (CIFS) and system message block (SMB).

7. The apparatus of claim 1, wherein said secure virtualized hypervisor comprises a sandbox.

8. An apparatus, comprising:
a network attached storage (NAS) storage controller for accessing data in a NAS data store; and
a secure virtualized hypervisor for deploying an operating system of a network attached storage (NAS) storage controller for purposes of secure operation by said storage controller, wherein said NAS storage controller is configured for receiving a command and associated command parameters that are migrated from an application executed by a client device to said NAS storage controller for purposes of accessing specified data stored in said NAS data store, wherein said specified data is fetched into said secure virtualized hypervisor and said command is executed by said NAS storage controller on said specified data within said secure virtualized hypervisor.

9. The apparatus of claim 8, further comprising a file system protocol configured for communicating with said NAS storage controller and accessing data in said NAS data store by initiating said NAS storage controller to perform said command on said specified data, wherein results of execution of said command is transmitted over a communication session to said client device, wherein said communication session is established between said client device and said NAS storage controller.

10. The apparatus of claim 9, wherein said file system protocol comprises at least one of a common internet file system (CIFS) and system message block (SMB).

11. The apparatus of claim 9, further comprising:
search and pattern recognition operations embedded into said file system protocol, wherein said file system protocol by extending said file sharing protocol to include said command, wherein said command comprises multiple components taken from a group consisting of said search and pattern recognition operations including at least one of an open command, a read command, a search command, a scan command, and a write command.

12. A method for accessing data, comprising:
receiving at a storage controller a command and associated command parameters from a client device to access specified data stored in a data store, wherein said storage controller manages access to said enterprise data store, wherein said storage controller and said data store comprise an enterprise data system;
deploying an operating system of said storage controller within a secure virtualized hypervisor for purposes of secure operation by said storage controller;
fetching said specified data from said data store as directed by said storage controller when executing said command;
storing said specified data in memory associated with said hypervisor as directed by said storage controller when executing said command; and
performing said command on said data stored in said hypervisor as directed by said storage controller.

13. The method of claim 12, further comprising:
generating a result of said performing said at least one instruction; and
sending said result to said client device.

14. The method of claim 12, wherein said command comprises at least one of search and pattern recognition operations.

15. The method of claim 14 further comprising:
embedding said search and pattern recognition operations into an enterprise file sharing protocol used for accessing said enterprise data system by extending said enterprise file sharing protocol to include said command, wherein said command comprises multiple components including at least one of an open command, a read command, a search command, a scan command, and a write command.

16. The method of claim 15, wherein said command comprises multiple components including a read command and a search command.

17. The method of claim 15,wherein said command comprises multiple components including a read command and a scan command.

18. The method of claim 15, wherein said enterprise file sharing protocol comprises at least one of a common internet file system (CIFS) and system message block (SMB).

19. The method of claim 12, further comprising:
establishing a communication session between said client device and said storage controller.

20. The method of claim 12, wherein said enterprise data system comprises a network attached storage (NAS), and said storage controller comprises a NAS controller.
